(19) United States
(12) Patent Application Publication
(10) Pub. No.: US 2020/0271077 A1
(43) Pub. Date: Aug. 27, 2020

(54) CANISTER WITH CERTAIN RANGE OF ACTIVATED CARBON VOLUME RATIO IN MAIN CHAMBER WITH RESPECT TO SUB CHAMBER

(71) Applicant: FUTABA INDUSTRIAL CO., LTD., Okazaki-shi (JP)

(72) Inventors: Takuya Nakagawa, Okazaki-shi (JP); Masahito Hosoi, Okazaki-shi (JP); Kyohei Yamaguchi, Okazaki-shi (JP)

(21) Appl. No.: 15/931,183

(22) Filed: May 13, 2020

Related U.S. Application Data
(63) Continuation of application No. 16/221,013, filed on Dec. 14, 2018.

(30) Foreign Application Priority Data
Dec. 20, 2017 (JP) 2017-243889

(51) Int. Cl. F02M 25/08; B01D 53/04; B60K 15/035; B67D 7/04

(52) U.S. Cl. CPC F02M 25/0854; B01D 53/0415; B60K 15/03504; B67D 7/0476; B01D 2257/702; F02M 25/0872; B01D 2253/102; B01D 2258/06; B60K 2015/03514

(57) ABSTRACT

A canister includes a charge port, a purge port, an atmosphere port, a main chamber, a sub chamber, activated carbon, and more activated carbon. The charge port takes in evaporated fuel. The purge port discharges the evaporated fuel. The atmosphere port is open to the atmosphere. The charge port and the purge port are connected to the main chamber. The sub chamber communicates with the main chamber. The atmosphere port is connected to the sub chamber. The activated carbon is stored in a main volume (Vmain) in the main chamber. The more activated carbon is stored in a sub volume (Vsub) in the sub chamber. A ratio of a length L in a gas flow direction to an equivalent diameter D in a section perpendicular to the gas flow direction is 2 or more for the sub chamber. An activated carbon volume ratio (Vmain/Vsub) is 5.5 to 7.

### CROSS-REFERENCE TO RELATED APPLICATIONS

This application is a continuation of U.S. patent application Ser. No. 16/221,013 filed on Dec. 14, 2018 and subsequently published as U.S. Patent Application Publication No. 2019/0186426A1, and claims priority to Japanese Patent Application No. 2017-243889 filed on Dec. 20, 2017, wherein the entire disclosures of the foregoing applications are hereby incorporated by reference herein.

### BACKGROUND

The present disclosure relates to a canister.

A canister, which inhibits release of evaporated fuel to the atmosphere, is attached to a fuel tank of a vehicle. The canister absorbs the evaporated fuel to activated carbon, desorbs fuel from the activated carbon with aspirated air for purging, and supplies the purged fuel to an engine.

Generally, the canister at least includes a main chamber to which a charge port is connected, and a sub chamber connected to the main chamber. Each of the main chamber and the sub chamber stores activated carbon. Also, in order to adjust absorption efficiency, a ratio (L/D) of a length L in a gas flow direction to an equivalent diameter D in a section perpendicular to the gas flow direction is designed appropriately for each chamber (see Japanese Unexamined Patent Application Publication No. 2005-16329).

### SUMMARY

In recent years, an engine capacity is decreasing due to hybridization, downsizing, etc., and a purge volume for a canister is also decreasing. When the purge volume decreases, desorption of evaporated fuel from activated carbon by purging becomes insufficient in a sub chamber which is closer to an atmosphere port than a main chamber, and the evaporated fuel left in the sub chamber can be later discharged from the atmosphere port. Also, when butane after filled into the canister for purging is left in the sub chamber, butane will be released to the atmosphere.

The present inventors found that, by adjusting a volume of the activated carbon in the sub chamber and the main chamber appropriately, while keeping the L/D of the sub chamber to a certain level or more, it is possible to limit release of the evaporated fuel and the like via the atmosphere port.

In one aspect of the present disclosure, it is preferable to provide a canister that can limit release of absorbed substances from an atmosphere port.

One aspect of the present disclosure provides a canister. The canister comprises a charge port, a purge port, an atmosphere port, a main chamber, a sub chamber, activated carbon, and more activated carbon. The charge port takes in an evaporated fuel. The purge port discharges the evaporated fuel. The atmosphere port is open to the atmosphere. The charge port and the purge port are connected to the main chamber. The sub chamber communicates with the main chamber. The atmosphere port is connected to the sub chamber directly or via an additional chamber. The activated carbon is stored in a main volume (Vmain) in the main chamber. The more activated carbon is stored in a sub volume (Vsub) in the sub chamber.

Further, a ratio L/D of a length L in a gas flow direction to an equivalent diameter D in a section perpendicular to the gas flow direction is 2 or more for the sub chamber. An activated carbon volume ratio (Vmain/Vsub) is 5.5 to 7, inclusive.

Another aspect of the present disclosure provides a canister. The canister comprises a charge port, a purge port, an atmosphere port, a main chamber, a sub chamber, activated carbon, more activated carbon, and a plurality of rod-like portions. The charge port takes in the evaporated fuel. The purge port discharges the evaporated fuel. The atmosphere port is open to the atmosphere. The charge port and the purge port are connected to the main chamber. The sub chamber communicates with the main chamber. The atmosphere port is connected to the sub chamber directly or via an additional chamber. The activated carbon is stored in a main volume (Vmain) in the main chamber. The more activated carbon is stored in a sub volume (Vsub) in the sub chamber. The plurality of rod-like portions are arranged such that surrounding spaces communicate with each other in the sub chamber.

Further, a ratio L/D of a length L in a gas flow direction to an equivalent diameter D in a section perpendicular to the gas flow direction is 2 or more for the sub chamber. An activated carbon volume ratio (Vmain/Vsub) is 5.5 to 10, inclusive.

According to the configurations as above, by setting the volume ratio of the activated carbon stored in the main chamber to the activated carbon stored in the sub chamber in a certain range, it is possible to reduce residual amount of absorbed substances in the sub chamber after purging while limiting an increase in pressure loss. As a result, release of the absorbed substances from the atmosphere port can be limited. In addition, by setting the L/D in the sub chamber to 2 or more, more gas comes into contact with the absorbed substances in the sub chamber. While reducing a capacity (volume holding activated carbon) of the sub chamber, it is possible to maintain absorption and desorption efficiency in the sub chamber.

In one aspect of the present disclosure, a ratio of a volume of purge air (Vpurge) to the volume of the activated carbon stored in the sub chamber (Vsub) may be 600 or more. According to the configuration as such, desorption of the absorbed substances such as the evaporated fuel in the sub chamber by purging is facilitated. Therefore, release of the absorbed substances from the atmosphere port can be more reliably limited.

It should be noted that the “equivalent diameter D in the section perpendicular to the gas flow direction” in the sub chamber means a value obtained by, for example, averaging a diameter (D=(S/π)^{1/2}×2) of a perfect circle having the same area as a section S, which is a section perpendicular to the gas flow direction in the sub chamber, along the gas flow direction in the sub chamber.

### BRIEF DESCRIPTION OF THE DRAWINGS

An example embodiment of the present disclosure will be described hereinafter with reference to the accompanying drawings, in which:

FIG. 1A is a schematic sectional view of a canister according to an embodiment, and FIG. 1B is a schematic side view of the canister of FIG. 1A;

FIG. 2 is a schematic sectional view of a canister according to an embodiment different from the embodiment in FIG. 1A;

FIG. 3 is a schematic sectional view of a canister according to an embodiment different from the embodiments in FIGS. 1A and 2;

FIG. 4 is a schematic sectional view of a canister according to an embodiment different from the embodiments in FIGS. 1A, 2, and 3;

FIG. 5A is a graph showing a relationship between a volume ratio of activated carbon in a sub chamber and a main chamber in the embodiments, and a ventilation resistance, and FIG. 5B is a graph showing a relationship between a volume ratio of activated carbon in the sub chamber and the main chamber of the embodiments, and a discharge amount in a DBL test; and

FIG. 6 is a graph showing a relationship between a purge amount and a desorption rate of absorbed substances in the embodiments.

### DETAILED DESCRIPTION OF THE PREFERRED EMBODIMENTS

### 1. First Embodiment

[1-1. Configuration]

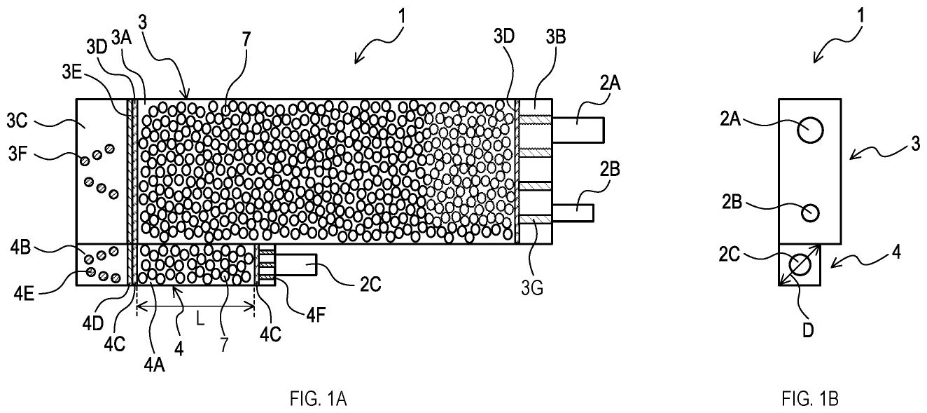

A canister 1 shown in FIG. 1A absorbs and desorbs evaporated fuel generated in a fuel tank of a vehicle. The term “absorb” is used broadly in this specification and claims, and is hereby defined to include absorption. The canister 1 comprises a charge port 2A, a purge port 2B, an atmosphere port 2C, a main chamber 3, a sub chamber 4, and activated carbon 7.

<Port>

The charge port 2A is connected to the fuel tank of the vehicle via piping. The charge port 2A is configured to pass the evaporated fuel generated in the fuel tank into the canister 1.

The purge port 2B is connected to an intake pipe of an engine of the vehicle via a one-way purge valve (not shown). The purge port 2B is configured to discharge the evaporated fuel inside the canister 1 from the canister 1 and supply the evaporated fuel to the engine.

The atmosphere port 2C is connected to a filling port of the vehicle via piping, and is open (through the filling port) to the atmosphere. The atmosphere port 2C releases gas from which the evaporated fuel has been removed to the atmosphere. Also, the atmosphere port 2C takes in external air (that is, purge air) to desorb (that is, purge) the evaporated fuel absorbed by the canister 1.

<Main Chamber>

The main chamber 3 stores the activated carbon 7, and absorbs the evaporated fuel received from the charge port 2A. Also, the main chamber 3 discharges the absorbed evaporated fuel through the purge port 2B.

The main chamber 3, as shown in FIG. 1A, is partitioned by a filter 3D into a first space 3A, a second space 3B, and a third space 3C. The filter 3D is configured to retain the activated carbon 7 but to be able to pass the gas.

The first space 3A is arranged so as to be interposed between the second space 3B and the third space 3C. The first space 3A is filled with the activated carbon 7. The first space 3A has a larger volume than the second space 3B and the third space 3C.

The second space 3B is adjacent to the first space 3A. The charge port 2A and the purge port 2B are connected to the second space 3B. The second space 3B is not filled with the activated carbon 7. In addition, ribs 3G extend from a housing, press the filter 3D, and are located in the second space 3B.

The third space 3C is arranged on an opposite side of the second space 3B relative to the first space 3A. The third space 3C communicates with a later-described second space 4B of the sub chamber 4. Note that the third space 3C is not filled with the activated carbon 7. In addition, a resin plate 3E having at least one through hole, and a spring 3F which presses the resin plate 3E and the filter 3D toward the first space 3A are located in the third space 3C.

<Sub Chamber>

The sub chamber 4 stores the activated carbon 7, and communicates with the main chamber 3 so that gas can be freely circulated between the main chamber 3 and the sub chamber 4. The sub chamber 4, as shown in FIG. 1A, is partitioned into a first space 4A and the second space 4B by a filter 4C. The filter 4C is similar to the filter 3D of the main chamber 3.

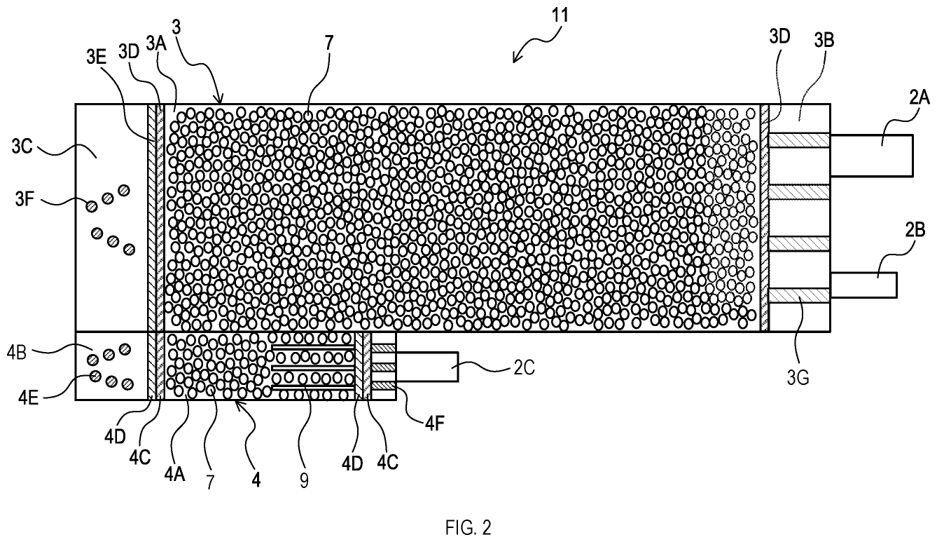

The first space 4A is filled with the activated carbon 7. Also, the atmosphere port 2C is connected to the first space 4A. The filter 4C, and ribs 4F (which extend from the housing and press the filter 4C) are arranged between the first space 4A and the atmosphere port 2C. A resin plate may be arranged between the first space 4A and the atmosphere port 2C (not shown in FIG. 1A, shown as 4C in FIG. 2).

The second space 4B is adjacent to the first space 4A. The third space 3C of the main chamber 3 is connected to the second space 4B. The second space 4B is not filled with the activated carbon 7. In addition, a resin plate 4D having a through hole, and a spring 4E which presses the resin plate 4D and the filter 4C toward the first space 4A are located in the second space 4B.

The sub chamber 4 is not connected to the main chamber 3 in a portion other than the second space 4B. In other words, the main chamber 3 and the sub chamber 4 are connected only by a flow path inside of the third space 3C and the second space 4B.

The evaporated fuel taken in from the charge port 2A passes the second space 3B of the main chamber 3, and is absorbed by the activated carbon 7 in the first space 3A. If the engine is not on, then evaporated fuel which cannot be absorbed in the first space 3A passes the third space 3C to the sub chamber 4, and is absorbed by the activated carbon 7 in the first space 4A of the sub chamber 4. Gas with the absorbed evaporated fuel is released from the atmosphere port 2C.

By supplying air from the atmosphere port 2C during a purge cycle (while the engine is running), the evaporated fuel absorbed by the activated carbon 7 in the first space 4A of the sub chamber 4, together with the evaporated fuel absorbed by the activated carbon 7 in the first space 3A of the main chamber 3, are discharged from the purge port 2B to the engine. As a result, air including the evaporated fuel (that was temporarily absorbed by carbon) is supplied to the engine.

<L/D, “Length to Diameter Ratio” of First Space in Sub Chamber>

In the first space 4A filled with the activated carbon 7 in the sub chamber 4, a ratio L/D of a length L [mm] in a gas flow direction to an equivalent diameter D [mm] in a section perpendicular to the gas flow direction (see FIG. 1B) is 2 or more. In case that the L/D is less than 2, a sectional area of the activated carbon increases and it becomes difficult for the gas to flow radially outward of the atmosphere port 2C. As a result, portions of the activated carbon 7 in the first space 4A do not effectively contact the flowing gas. In other words, absorption efficiency of the canister 1 is significantly reduced. It is preferable that the L/D is 2.5 or more, and even more preferably 3.0 or more.

<Vmain/Vsub, Activated Carbon Volume Ratio>

A ratio (hereinafter, “activated carbon volume ratio”) of a volume of the activated carbon 7 stored in the main chamber 3 (that is, volume of the first space 3A, also known as Vmain) to a volume of the activated carbon 7 stored in the sub chamber 4 (that is, volume of the first space 4A, also known as Vsub) is 5.5 to 7. Thus, a general range is: 5.5≤Vmain/Vsub≤7.

It is preferable that a lower limit of the activated carbon volume ratio is 6.0. It is preferable that an upper limit of the activated carbon volume ratio is 6.5. Thus, a preferred range is: 6≤Vmain/Vsub≤6.5. The term “volume of the activated carbon” includes voids between the carbon particles.

If the activated carbon volume ratio is less than 5.5, then there is a possibility that a desorption property of the evaporated fuel in the sub chamber 4, that is, diurnal breathing loss (DBL) performance, may decrease. To the contrary, in case that the activated carbon volume ratio is more than 7, there is a possibility that pressure loss may become too large due to increase in ventilation resistance of the canister 1.

<BV=Vpurge/Vsub=Volume of Purge Air Divided by Volume of First Space>

A ratio of a volume of the purge air to the volume of the activated carbon 7 stored in the sub chamber 4 (hereinafter, “BV”) is preferably 600 or more. Thus, Vpurge/Vsub≥600. In case that the BV is less than 600, there is a possibility that desorption of the evaporated fuel and butane may be insufficient during the purge cycle, and the evaporated fuel and butane may later be easily released from the atmosphere port 2C. For example, in case that the volume of the purge air is 200 L, and the volume of the activated carbon 7 in the sub chamber 4 is 0.3 L, the BV becomes 667 times. It is preferable that the BV is 650 times or more, and more preferably 700 times or more.

<Activated Carbon>

The activated carbon 7 absorbs the evaporated fuel supplied to the canister 1 together with air and the like, and butane. Also, the activated carbon 7 introduces external air to desorb the evaporated fuel and butane. The desorbed evaporated fuel is supplied to the engine.

Well-known types activated carbon can be used as a stock of the activated carbon 7. In the present embodiment, an aggregate of granular activated carbon is used as the activated carbon 7. The activated carbon 7 stored in the main chamber 3, and the activated carbon 7 stored in the sub chamber 4 may be of the same kind or different kinds.

[1-2. Effect]

According to the embodiment described in detail above, the following effect can be achieved.

(1a) The activated carbon volume ratio (Vmain/Vsub) is set to be 5.5 to 7. Therefore, while limiting an increase in pressure loss due to decrease in flow path sectional area of the sub chamber 4, residual amount of absorbed substances in the sub chamber 4 can be reduced earlier with a less purge amount. As a result, release of absorbed substances from the atmosphere port 2C can be limited. Also, the L/D of the sub chamber 4 is set to be 2 or more. Since more gas contacts the absorbed substance in the sub chamber 4, it is possible to maintain absorption and desorption efficiency in the sub chamber 4 while reducing the capacity of the sub chamber 4.

### 2. Second Embodiment

[2-1. Configuration]

A canister 11 shown in FIG. 2 absorbs and desorbs evaporated fuel generated in a fuel tank. The canister 11 comprises the charge port 2A, the purge port 2B, the atmosphere port 2C, the main chamber 3, the sub chamber 4, the activated carbon 7, and rod-like portions 9.

The charge port 2A, the purge port 2B, the atmosphere port 2C, the main chamber 3, the sub chamber 4, and the activated carbon 7 of the canister 11 are the same as those of the canister 1 of FIG. 1A. Therefore, the same reference numbers are given to those components, and the description thereof is not repeated.

<Rod-Like Portions>

The rod-like portions 9 are attached to the resin plate 4D (located near the atmosphere port 2C), and are arranged in such a manner that surrounding spaces communicate with each other in the first space 4A of the sub chamber 4. In other words, the rod-like portions 9 are arranged so as to be separated from each other, and the activated carbon 7 is filled between the rod-like portions 9. Also, each of the rod-like portions 9 extends in the gas flow direction from a side connected to the atmosphere port 2C of the sub chamber 4.

In the vicinity of the rod-like portions 9, density of the activated carbon 7 is lower than in other areas, due to additional voids being created adjacent to the rod-like portions 9. Therefore, in the vicinity of the rod-like portions 9, fuel vapor and purge air flow easily. As a result, ventilation resistance of the sub chamber 4 is reduced.

The rod-like portions 9 do not necessarily extend in parallel with the bulk gas flow direction (horizontally in FIG. 2). Each of the rod-like portions 9 may extend so as to be curved or bent at one or more positions or may extend spirally. Also, the rod-like portions 9 may have different shapes. Further, the rod-like portions 9 may extend in a direction different from the gas flow direction. Also, the rod-like portions 9 may extend in directions different from each other.

<Vmain/Vsub, Activated Carbon Volume Ratio>

In the present embodiment, the volume ratio of the activated carbon 7 stored in the main chamber 3 to the activated carbon 7 stored in the sub chamber 4 is 5.5 to 10.

If the activated carbon volume ratio is less than 5.5, there is a possibility that desorption of the evaporated fuel in the sub chamber 4, that is, DBL (diurnal breathing loss) performance, may decrease. On the contrary, if the activated carbon volume ratio is more than 10, there is a possibility that pressure loss may become too large due to an increase in ventilation resistance of the canister 11. In the present embodiment, since pressure loss of the sub chamber 4 is reduced by the rod-like portions 9, the activated carbon volume ratio in canister 11 of FIG. 2 can be made larger than the canister 1 of FIG. 1A.

[2-2. Effect]

According to the embodiment described in detail above, the following effect can be achieved.

(2a) The rod-like portions 9 reduce pressure loss of the sub chamber 4. Therefore, the L/D of the sub chamber 4 can be increased. As a result, absorption and desorption performance is improved. In addition, it is possible to reduce a size of the sub chamber 4, and increase an upper limit of the activated carbon volume ratio. As a result, a degree of freedom in designing a canister is increased.

### 3. Third Embodiment

[3-1. Configuration]

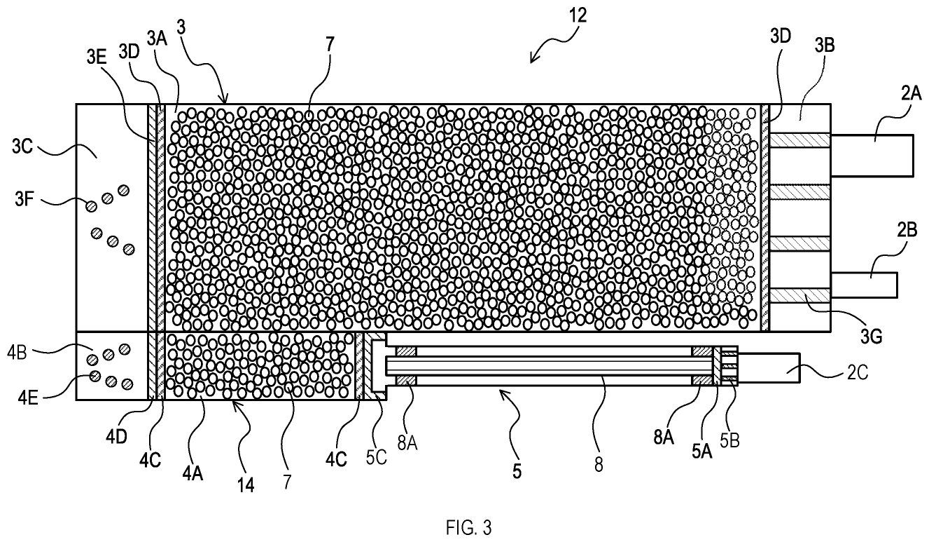

A canister 12 shown in FIG. 3 absorbs and desorbs evaporated fuel generated in a fuel tank. The canister 12 comprises the charge port 2A, the purge port 2B, the atmosphere port 2C, the main chamber 3, a sub chamber 14, a third chamber 5, and activated carbon 7, 8.

The charge port 2A, the purge port 2B, the atmosphere port 2C, the main chamber 3, and the activated carbon 7 of the canister 12 are the same as those of the canister 1 of FIG. 1A. Therefore, the same reference numbers are given to those components, and the description thereof is not repeated.

<Sub Chamber>

The sub chamber 14 is the same as the sub chamber 4 of FIG. 1A, except that the third chamber 5 is inserted between the first space 4A and the atmosphere port 2C.

<Third Chamber>

The third chamber 5 stores the activated carbon 8 (in a honeycombed shape), and communicates with the sub chamber 14 so that gas can flow freely between the sub chamber 14 and the third chamber 5. A volume (Vhoney) of the activated carbon 8 stored in the third chamber 5 is smaller than that of the activated carbon 7 stored in the sub chamber 14.

The third chamber 5 is connected to the first space 4A of the sub chamber 14. Also, the atmosphere port 2C is connected to the third chamber 5 at a position facing a portion connected to the sub chamber 14. In other words, the third chamber 5 of the present embodiment is arranged between the sub chamber 4 and the atmosphere port 2C of the canister 1 shown in FIG. 1A.

The third chamber 5 stores so-called honeycomb shaped molded activated carbon which is formed into a tubular shape and has through holes, as the activated carbon 8. The molded activated carbon is obtained by extruding a material, including carbon mixed with ceramic as a binder, into a certain shape.

The activated carbon 8 is arranged inside the third chamber 5 so that central axes of the through holes follow the bulk gas flow direction. In other words, the through holes of the activated carbon 8 are configured so that gas can easily pass in a direction of the central axes. When gas containing the evaporated fuel passes through the through holes of the activated carbon 8, the evaporated fuel is absorbed by the activated carbon 8.

The activated carbon 8 is optionally arranged inside the third chamber 5 by holders 8A. The holders 8A are configured by a filter or rubber, for example. A filter 5A, and ribs 5B (which extend from a housing and presses the filter 5A) are arranged between the third chamber 5 and the atmosphere port 2C. Also, a resin plate 5C is arranged between the third chamber (honey chamber) 5 and the sub chamber 14.

Shapes of the through holes of the molded activated carbon are not specifically limited. Therefore, the through holes may have a shape including a curve, other than a polygon such as a quadrangle or a hexagon. An example of the through holes including a curve is formed by arranging corrugated sheets one by one between flat sheets arranged in parallel.

[3-2. Effect]

According to the embodiment described in detail above, the following effect can be achieved.

(3a) The third chamber 5 (honey chamber) provides absorption of the evaporated fuel from the sub chamber 14. As a result, it is possible to more reliably limit release of absorbed substances from the atmosphere port 2C.

### 4. Other Embodiments

The embodiments of the present disclosure have been described in the above. The present disclosure is not limited to the embodiments described above, and can take various forms.

(4a) In the canister 12 of the above-described embodiment, the activated carbon 8 stored in the third chamber 5 is not limited to a honeycomb shaped molded activated carbon.

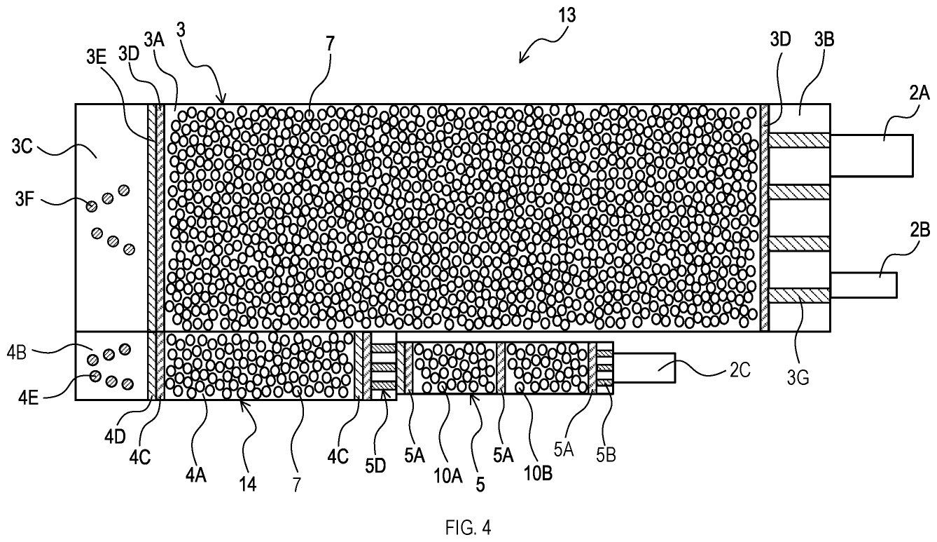

Also, as shown in a canister 13 shown in FIG. 4, two types of activated carbon 10A, 10B may be arranged inside the third chamber 5 in a manner divided upstream and downstream of a gas flow path. In FIG. 4, the third chamber 5 is partitioned by the filters 5A. In addition, a resin grid 5D is arranged between the third chamber 5 and the sub chamber 14.

In the canister 13 of FIG. 4, the activated carbon 10B is stored in an area of the third chamber 5 closer to the atmosphere port 2C, and the activated carbon 10A is stored in an area of the third chamber 5 closer to the sub chamber 14. The activated carbon 10A has higher absorption capacity than the activated carbon 10B. The activated carbon 10A, 10B arranged as such can reliably limit leaking of the evaporated fuel and the like from the sub chamber 14 to the atmosphere port 2C.

(4b) In the canister 11 of the above-described embodiment, the third chamber 5 shown in FIG. 3 or 4 may be provided between the sub chamber 14 and the atmosphere port 2C.

(4c) A function of a single component in above-described embodiments may be distributed as a plurality of components or functions of a plurality of components may be integrated into a single component. It is also possible to omit a part of the configuration of the above embodiments. Further, at least a part of the configuration of one of the above embodiments may be added, substituted, or the like, to the configuration of the other of the above embodiments. Any aspects within the technical idea specified from the wording of the claims are embodiments of the present disclosure.

### 5. Example

Hereinafter, experiments conducted to confirm the effect of the present disclosure, and their evaluations, will be described.

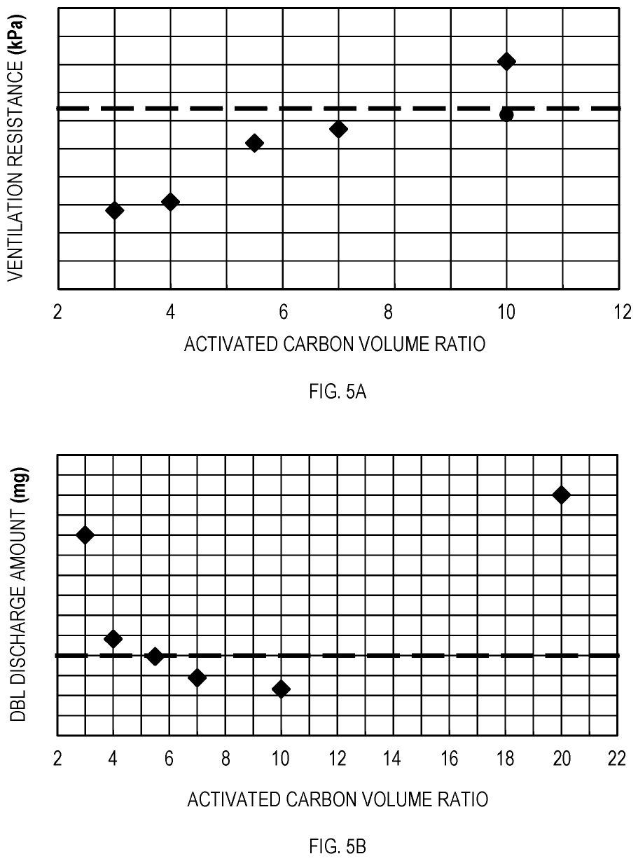

A graph in FIG. 5A shows changes in ventilation resistance at a ventilation volume of 50 Lit/min (liters per minute) when the activated carbon volume ratio in the canisters in FIGS. 2, 3 and 4 are changed. In FIG. 5A, diamond-shaped plots are data of the canisters 12 and 13 in FIGS. 3 and 4, and circular plots are data of the canister 11 in FIG. 2. Also, broken lines in FIG. 5A show ventilation resistance of 0.85 kPa required for refueling performance of a vehicle.

In view of the data in FIG. 5A, in the canisters 12 and 13, the ventilation resistance can be 0.85 kPa or less by setting the activated carbon volume ratio to be 7 or less. Also, in the canister 11 having the rod-like portions 9, the ventilation resistance (pressure loss) can be 0.85 kPa by setting the activated carbon volume ratio (Vmain/Vsub) to be 10 or less (see the circle in FIG. 5A). This ventilation resistance is merely an example. It can be seen that a canister having rod-like portions can decrease ventilation resistance (decrease pressure drop) by about 15% with respect to a canister without the rod-like portions. Accordingly, the ventilation resistance of the canister having the rod-like portions may be estimated based on the ventilation resistance of the canister without the rod-like portions so as to calculate an activated carbon volume ratio that will yield the desired properties.

Also, a graph in FIG. 5B shows changes in discharge amount (that is, released amount of butane after purging) in the DBL test when the activated carbon volume ratio (Vmain/Vsub) is changed in the canisters 12 and 13 in FIGS. 3 and 4. Broken lines in FIG. 5B show an upper limit of 20 mg of vehicle emission standards in regulations.

The DBL discharge amount depends on the activated carbon volume ratio, and is not substantially affected by presence or absence of the rod-like portions. As shown in FIG. 5B, when the volume ratio of the activated carbon (Vmain/Vsub) is 10 to less than 20, the DBL discharge amount can be 20 mg or less.

Accordingly, in consideration of the ventilation resistance and the DBL discharge amount, the activated carbon volume ratio is preferably set to 5.5 to 7 in the canister without the rod-like portions, and the activated carbon volume ratio is preferably set to 5.5 to 10 in the canister having the rod-like portions. In this way, while reducing the ventilation resistance, it is possible to limit release of absorbed substances from an atmosphere port.

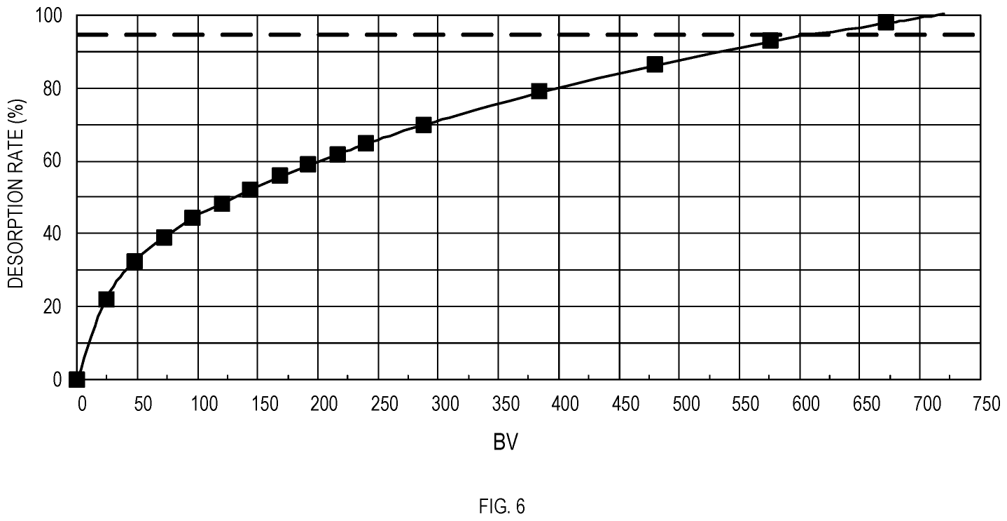

A graph in FIG. 6 shows changes in butane desorption rate inside the sub chamber 4 after purging when the BV is changed in the sub chamber 4 in the canister 1 of FIG. 1A. Broken lines in FIG. 6 show a desorption rate of 95%.

As shown in FIG. 6, when the BV is 600 or more, the desorption rate can be 95% or more.

What is claimed is:

1. A canister that absorbs and desorbs evaporated fuel generated in a fuel tank of a vehicle, the canister comprising:
a charge port that takes in evaporated fuel;
a purge port that discharges the evaporated fuel;
an atmosphere port open to the atmosphere;
a main chamber to which the charge port and the purge port are connected;
a sub chamber communicating with the main chamber, the atmosphere port being connected to the sub chamber directly or via an additional chamber;
activated carbon stored in a main volume (Vmain) in the main chamber;
more activated carbon stored in a sub volume (Vsub) in the sub chamber,
a third chamber communicating with the sub chamber, the atmosphere port being connected to the third chamber; and
a first activated carbon and a second activated carbon which are arranged inside the third chamber,
wherein a ratio L/D of a length L in a gas flow direction to an equivalent diameter D in a section perpendicular to the gas flow direction is 2 or more for the sub chamber,
an activated carbon volume ratio (Vmain/Vsub) is 5.5 to 7, inclusive, and
the first activated carbon is stored in an area of the third chamber closer to the sub chamber than the second activated carbon, and the first activated carbon has higher absorption capacity than the second activated carbon.

2. A canister that absorbs and desorbs evaporated fuel generated in a fuel tank of a vehicle, the canister comprising:
a charge port that takes in evaporated fuel;
a purge port that discharges the evaporated fuel;
an atmosphere port open to the atmosphere;
a main chamber to which the charge port and the purge port are connected;
a sub chamber communicating with the main chamber, the atmosphere port being connected to the sub chamber directly or via an additional chamber;
activated carbon stored in a main volume (Vmain) in the main chamber;
more activated carbon stored in a sub volume (Vsub) in the sub chamber;
a plurality of rode like portions arranged such that surrounding spaces communicate with each other in the sub chamber;
a third chamber communicating with the sub chamber, the atmosphere port being connected to the third chamber; and
a first activated carbon and a second activated carbon which are arranged inside the third chamber,
wherein a ratio L/D of a length L in a gas flow direction to an equivalent diameter D in a section perpendicular to the gas flow direction is 2 or more for the sub chamber,
an activated carbon volume ratio (Vmain/Vsub) is 5.5 to 10, inclusive, and
the first activated carbon is stored in an area of the third chamber closer to the sub chamber than the second activated carbon, and the first activated carbon has higher absorption capacity than the second activated carbon.

3. The canister according to claim 1, wherein a ratio of a volume of purge air (Vpurge) to the volume of the activated carbon stored in the sub chamber (Vsub) is 600 or more.
